(19) United States
(12) Patent Application Publication
(10) Pub. No.: US 2024/0215768 A1
(43) Pub. Date: Jul. 4, 2024

(54) PANCAKE MOLD

(71) Applicant: Kevin Delaney, Pendleton, IN (US)

(72) Inventor: Kevin Delaney, Pendleton, IN (US)

(21) Appl. No.: 18/188,424

(22) Filed: Mar. 22, 2023

Related U.S. Application Data
(63) Continuation of application No. 18/149,502, filed on Jan. 3, 2023, now abandoned.

(51) Int. Cl. A47J 43/20; A21D 13/44

(52) U.S. Cl. CPC A47J 43/20; A21D 13/44

(57) ABSTRACT

A pancake making assembly, including an endless flexible wall member having a first side and an oppositely disposed, generally parallel second side, a support structure operationally connected to the endless flexible wall member, and a negative mold operationally connected and depending from the support structure. The endless flexible wall member is sized and shaped to define a pancake. The endless flexible wall member and the negative mold are made of a heat resistant material.

### CROSS-REFERENCE TO RELATED APPLICATIONS

This patent application is a continuation-in-part of co-pending U.S. patent application Ser. No. 18/149,502, filed on Jan. 3, 2023, and claims priority thereto.

### TECHNICAL FIELD

This specification relates generally to the field of culinary science and, more specifically, to a silicon mold for suspension in pancake batter to yield custom designed pancakes.

### BACKGROUND

Virtually everyone enjoys a good pancake. The vast majority of folks enjoy butter, syrup, fruit, or some combination thereof on their pancakes. However, these toppings have a tendency to drain off the pancake, as the center is usually higher than the edges. Thus, there remains a need for a fun means to capture an hold toppings on the pancake. The present novel technology addresses this need.

### BRIEF DESCRIPTION OF THE DRAWINGS

FIG. 1A depicts a first top perspective view of a first embodiment pancake mold assembly according to the present novel technology.

FIG. 1B is a perspective view of the mold element of FIG. 1A with the handle portion engaged with the plug portion.

FIG. 1C is a perspective view of the mold element of FIG. 1A with the handle portion disengaged from the plug portion.

FIG. 2 depicts a second top perspective view of the pancake mold assembly of FIG. 1.

FIG. 3A depicts a third top perspective view of the pancake mold assembly of FIG. 1 with a pancake being formed therein.

FIG. 3B depicts a fourth top perspective view of a variant of the pancake mold assembly of FIG. 1 with the mold element support member connected directly to the pan and with a pancake being formed therein.

FIG. 4 depicts a top view of resulting pancake of FIG. 3A.

Like reference numbers and designations in the various drawings indicate like elements.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often, though may not always, occur and that the description includes instances where said event or circumstance occurs and instances where it does not.

The details of one or more embodiments of the subject matter described in this specification are set forth in the accompanying drawings and the description below. Other features, aspects, and advantages of the subject matter will become apparent from the description, the drawings, and the claims.

In general, the present novel technology relates to a mold for producing pancakes having a central depression or aperture for containing syrup and like condiments or food stuffs. The mold includes a ring member for defining and containing the pancake, an insert member for defining the central depression/aperture formed in the pancake, a suspension member for positioning and holding the insert member. The insert member typically has a simple yet visually appealing shape, such as a star, a heart, a smiley face, an animal, a fictional character, a historical figure, a cartoon character, or the like, and is more typically removably attachable to the suspension member so as to be readily swapped out for a different shape to lend variety to breakfast.

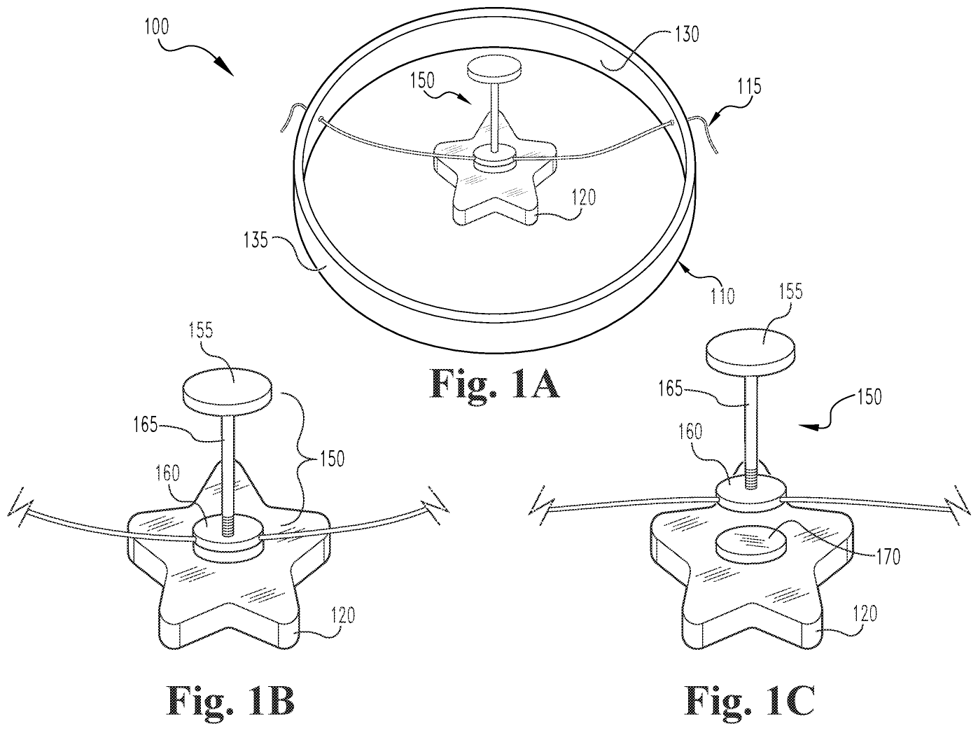

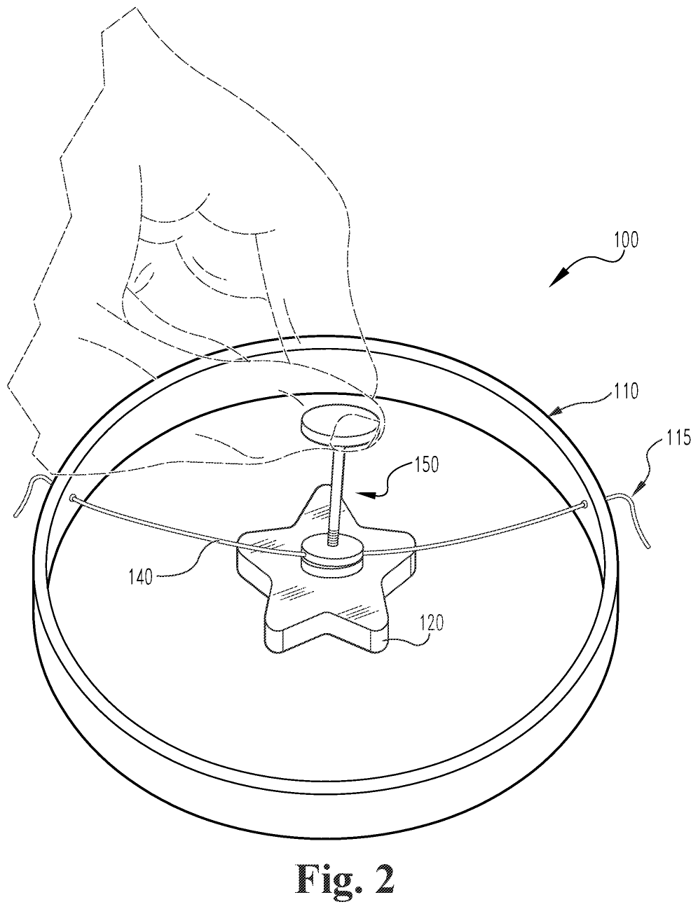

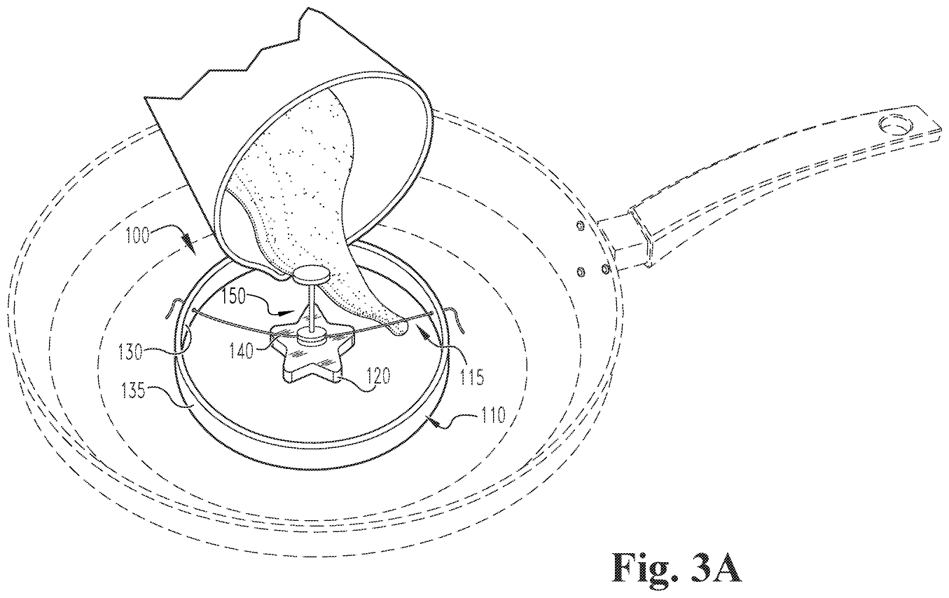

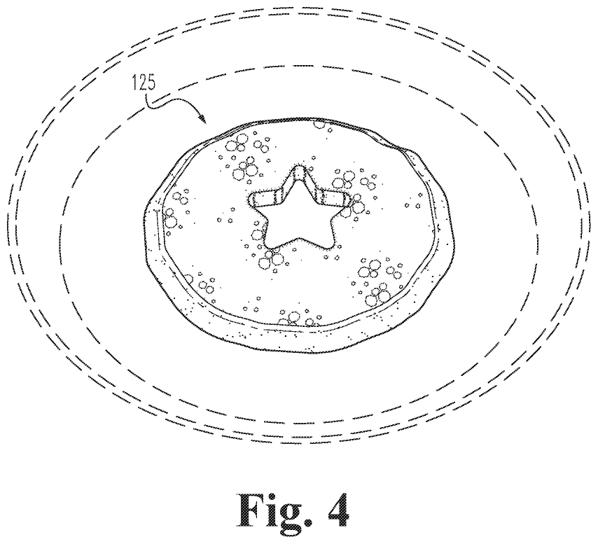

FIGS. 1A-4 depict various perspectives and embodiments associated with the instant novel pancake mold assembly 100, which typically may include an endless flexible wall member (also called ring member or ring portion herein) 110, a support structure 115, and a plug member (also called plug portion and/or negative mold member herein) 120 for making a built-in syrup well in a pancake. Specifically, FIGS. 1-3B depict top perspective views of the present novel pancake mold assembly 100, while FIG. 4 is a top perspective view of a pancake 125 made in the same.

Typically, pancake mold assembly 100 includes a ring member 110 defining parallel first and second oppositely disposed inner and outer surfaces 130, 135. More typically, first surface 130 may be considered the pancake (batter) engaging surface, while oppositely disposed second surface 135 may be considered the outer boundary surface. The ring member 110 is typically relatively thin, insofar as the distance between surfaces 130, 135 is substantially less than the diameter of the ring member 115. Described another way, the thickness of the ring member 130 is substantially less than the orthogonal height dimension extending within the planes defined by the respective typically flat surfaces 130, 135. The ring member 110 is typically made of a flexible, heat resistant material, such as silicone rubber or the like.

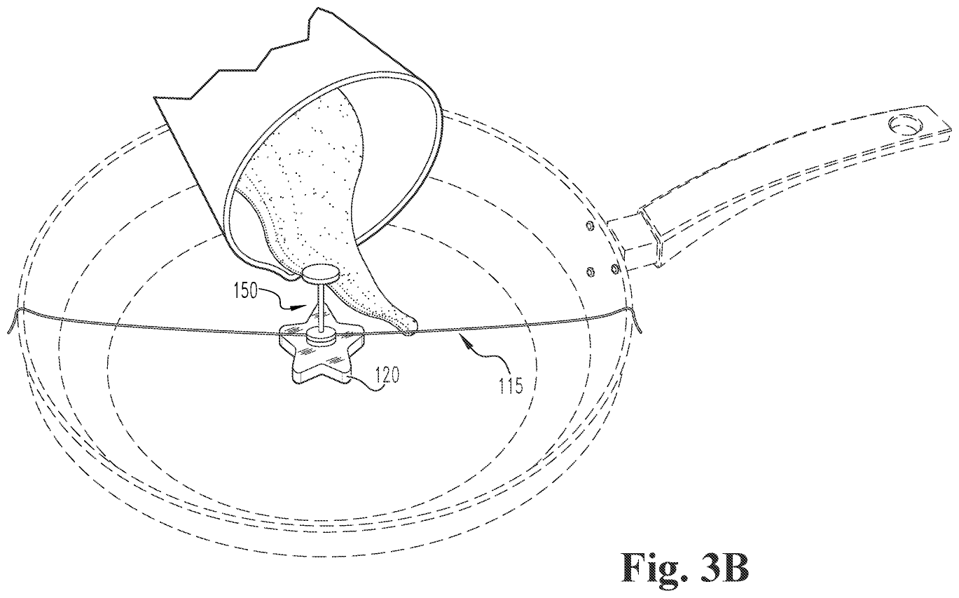

A support structure 115 is typically unitarily connected, or operationally connectable, to the ring member 110, engaging the ring member 110 at one or (typically) more points to provide an armature or boom arm 140 extending over the ring member 110 from which the plug member 120 may be suspended. The support structure 115 is typically made of a heat resistant structural material, such as hard silicone, metal, thermoplastic, or the like. The support structure 115 is typically flexible enough such that the suspended plug 120 may be adjusted and positioned within the pancake as desired. In some embodiments (see FIG. 3B), the support structure 115 is directly engageable with a pan without the requirement of the ring member 110.

The negative mold portion 120 is typically a solid piece of heat resistant structural material, such as silicone rubber, metal, composite material, ceramic, borosilicate glass, or the like, and is suspended from the support structure 115, such as by direct connection to the boom arm 140 or via an intermediate handle member 150 extending therefrom. The handle member 150 may include a grip portion 155, a plug engaging connection portion 160, and an elongated member 165 extending therebetween and connected to the grip and plug engaging portions 155, 160.

In some embodiments, the mold 120 and handle 150 portions are unitary, while in other embodiments the negative mold portion 120 likewise typically includes a mated handle engaging portion 170, whereas the engaging portions 160, 170 are matably disengageably engagable so as to function as connectors, allowing different plug portions 120 of different designs to be swapped out to make pancakes with a variety of designs contained therein. The engaging portions 160, 170 may be magnetic connectors, threaded connectors, snap-on connectors, or any convenient type of connectors. The boom arm 140 may be operationally connected to plug engaging portion 160 as shown, directly to the plug member 120 (not shown), to the handle portion 150, or the like. The negative mold portion 120 is sized and shaped to yield a depression or hole in the pancake of sufficient volume to contain a desired serving of syrup, butter, fruit, fruit jam, peanut butter, and the like, and combinations thereof, as might be desired by the diner.

In operation, the ring member 110 is placed into a (typically preheated) frying pan, griddle, electric frying pan, electric griddle, baking sheet or the like 145, with the support structure 115 operationally connected thereto. The support structure 115 may be directly connected to the ring member 110, independently positioned adjacent ring member 110 and suspended thereover, connected to the pan, or the like. Oil or shortening is typically added to the pan within the confines of the ring member 110, and pancake batter is poured thereinto. The plug member 120 is operationally connected to the support structure 115 and depends therefrom into the poured batter, displacing a portion of the same to define a depression. The pancake batter cooks until a pancake having a depression or aperture results. The plug member 120 is removed from the pancake and the pancake is removed from the pan and assembly for consumption.

Pancake size may be varied by using larger or smaller ring members 110, wherein the support structure 115 may be operationally connected to, and disconnected from, a particular ring member 115 as desired. In some embodiments, the ring member 110 may be non-circular to provide design cooperation with one or more mold assemblies 100.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A method for making a pancake having a depression formed therein to condiments, comprising:
a) engaging a ring member with a pan;
b) pouring batter into the ring member;
c) operationally connecting a support structure to the ring member;
d) suspending a negative mold from the support structure into the batter;
e) cooking the batter to yield a pancake;
f) removing the pancake from the pan and ring member;
wherein the pancake has a depression formed therein.

2. The method of claim 1, further comprising the steps of:
g) filling the depression with a condiment; and
h) eating the pancake.

3. The method of claim 1 wherein c) further comprises directly connecting the support structure to the ring member.

4. The method of claim 1 wherein c) further comprises directly connecting the support structure to the pan.

5. A pancake making assembly, comprising:
an endless flexible wall member having a first side and an oppositely disposed, generally parallel second side;
a support structure operationally connected to the endless flexible wall member; and
a negative mold operationally connected and depending from the support structure;
wherein the endless flexible wall member is sized and shaped to define a pancake; and
wherein the endless flexible wall member and the negative mold are made of a heat resistant material.

6. The assembly of claim 5 wherein the heat resistant material is silicone rubber.

7. The assembly of claim 5 wherein the heat resistant material is selected from the group consisting of silicone rubber, metal, composite material, ceramic, borosilicate glass, and combinations thereof.

8. The assembly of claim 5 wherein the negative mold has a shape selected from the group consisting of a star, a heart, a smiley face, an animal, a fictional character, a historical figure, and a cartoon character.

9. The assembly of claim 5 wherein the support structure is directly connected to the endless flexible wall member.

10. The assembly of claim 5 wherein the support structure is directly connected to a pan.

11. The assembly of claim 5 and further comprising a handle member extending between and operationally connecting the support structure and the negative mold.

12. The assembly of claim 11 wherein the handle member is unitary with the negative mold.

13. The assembly of claim 11 wherein the handle member is disengageably engageable with the negative mold.

14. A kit for making pancakes having built-in syrup wells, comprising:
an endless flexible wall member having a first side and an oppositely disposed, generally parallel second side;
a support structure operationally connectable to the endless flexible wall member; and
a negative mold operationally connectable to the support structure.

15. The kit of claim 14 and further comprising a handle member for connecting the support structure and the negative mold.

16. The kit of claim 14 wherein the handle member is unitary with the negative mold.

17. The kit of claim 14 wherein the handle member is disengageably engageable with the negative mold.

18. A pancake making apparatus, comprising:
a support structure operationally connected to a pan; and
a negative mold operationally connected and depending from the support structure;
wherein the endless flexible wall member and the negative mold are made of a heat resistant material.

19. The apparatus of claim 18 and further comprising a heat resistant endless flexible wall member having a first side and an oppositely disposed, generally parallel second side; wherein the endless flexible wall member is sized and shaped to define a pancake; and wherein the support structure is operationally connected to the pan through the endless flexible wall member.
